(19) United States
(12) Patent Application Publication
(10) Pub. No.: US 2004/0004534 A1
(43) Pub. Date: Jan. 8, 2004

(54) Chip type thick film resistance

(75) Inventors: Shih Chang Liao, Sanchung City (TW); Kang-Nen Hsu, Hsinchu Hsien (TW)

Correspondence Address: BRUCE H. TROXELL, SUITE 1404, 5205 LEESBURG PIKE, FALLS CHURCH, VA, 22041, US

(73) Assignee: Inpaq Technology Co., Ltd.

(21) Appl. No.: 10/453,641

(22) Filed: Jun. 4, 2003

(30) Foreign Application Priority Data
Jul. 2, 2002 (TW) 091210001

(51) Int. Cl. H01C 1/012

(52) U.S. Cl. 338/309

(57) ABSTRACT

An innovative structure for the chip type thick film resistance is disclosed. It comprises a copper structure electroplated to the conductor portion on an insulation layer, or comprises a copper structure electroplated to the conductor portion beneath a soldering interphase layer, or comprises both. With this structure, the resistance and the thermal resistivity of the product is greatly reduced, and the laser resistance trimming can be easily and precisely executed, also production yield will be satisfactorily improved.

### BACKGROUND OF THE INVENTION

1. Field of the Invention

The present invention relates to a chip type thick film resistance, and more particularly, to the improved structure of a chip type thick film resistance which has an extra conducting electroplated copper structure so as to reduce the resistance of the chip type thick film and its thermal resistivity, and improve the production yield.

2. Description of the Prior Art

In a modem electronic circuit, for instance, a feedback circuit, sensing or measurement of current value for controlling other electrical parameters is very important. For this reason, a chip type resistance element is widely and conveniently in use. However, the application of a conventional chip type thick film resistance has come to a narrow neck because of its high coefficient of thermal resistivitiy makes it impossible to keep a constant resistance when working at a heavy load which often accompanies with a high temperature rise in the circuit. In view of this, electronic engineers and manufacturers have tried to exploit new electronic components as replacement for the aforesaid chip type thick film resistance for a long time.

However, there is no discovery of anyone, which can defeat the superiority of the chip type thick film resistance. Therefore, it is a more economical and effective idea to develop an innovative structure for the conventional chip type thick film resistance, which can palliate the aforesaid shortcomings.

Here, let us review the structure and fabrication process for a conventional chip type thick film resistance. For this, reference should be made to FIGS. 1A to 1R, firstly, a conducting electrode layer 102 (See FIGS. 1C, 1D) is formed by coating on each side of the bottom surface of a ceramic substrate 101C (See FIGS. 1A, 1B); next, another conducting electrode layer 103 (See FIGS. 1E, 1F) is formed by coating on each side of the top surface thereof; further, a resistance layer 104 is formed by coating on the center portion of the top surface thereof (See FIGS. 1G, 1H); then, an insulation coating layer 105 is overlapped on the resistance layer 104 (See FIGS. 1I, 1J); afterwards, a resistance protecting layer 106 is covered on the insulation coating layer 105 by coating (See FIGS. 1K, 1L); moreover, a conducting electrode connecting layer 107 is coated on the electrode layers 102 and 103 which have been respectively formed on the top and the bottom surfaces of the ceramic substrate 101 (See FIGS. 1M, 1N); finally, a first soldering interface layer 108 (See FIGS. IO, IP), and a second soldering interface layer 109 (See FIGS. 1Q, 1R) are coated respectively on the top and the bottom surfaces' conducting electrode connecting layers 107 in order. This structure fabricated according to the method described above, except two electrode connecting layers 107 and the first and second soldering interface layers 108, 109, other layers are formed according to the standard printing process and materials. The conducting electrode material used by the thick film printing usually has a higher volume resistivity, moreover, its thermal resistivity is about 50 times as much compared with that of the material used in the resistance area. Consequently, such two factors inherent to the conducting electrode material cause the following problems:

1. Due to high volume resistivity of the electrode material that almost no difference with that of the resistance material used for fabricating a low resistance chip type thick film, accordingly, there encounters a problem of difficulty in performing a precise modification of the resistance value for the chip type thick film by laser trimming because the instrument probe cannot ensure an accurate contact point for measurement.

2. The high thermal resistivity of the electrode material results in a high overall resistance value of the chip type thick film even though the resistance material thereof has a low thermal resistivity owing to the fact the overall resistance is the sum of the above two.

If the above mentioned shortcomings are tried to be palliated by increasing the thickness of the single electrode layer, or by increasing the number of electrode layers which is equivalent to increasing the thickness, the minor improvement may be expected. On the other hand, the inevitable increase of the material cost, quantity and manpower etc. will prove such an attempt does not pay.

### SUMMARY OF THE INVENTION

Therefore, an invention devoting to resolving aforesaid disadvantages of the conventional chip type thick film resistance with an innovated structure is absolutely necessary.

Accordingly, it is an object of the present invention to provide an improved structure for a chip type thick film resistance in which the thermal resistivity of the conducting electrode layer is satisfactorily reduced so as to realize the overall resistance of a chip type thick film resistance culminating an ideal low value.

It is another object of the present invention to provide an improved structure for a chip type thick resistance whose precise modification of the resistance value can be easily and effectively carried out by laser trimming mode.

For achieving the above-mentioned objects, in the present invention, a copper conducting structure is formed on the conductor portion of an insulation coating by electroplating, or a copper conducting structure is formed beneath a resistance protecting layer by electroplating, or forming both of them.

The above objects and other advantages of the present invention will become more apparent by describing in detail the preferred embodiments of the present invention with reference to the attached drawings.

### BRIEF DESCRIPTION OF THE DRAWINGS

FIG. 1 is a schematic view illustrating structure and fabrication process of a conventional chip type thick film resistance;

FIG. 2 is a schematic view illustrating structure and fabrication process in a first embodiment of the present invention;

FIG. 3 is a schematic view illustrating structure and fabrication process in a second embodiment of the present invention.

### DETAILED DESCRIPTION OF THE PREFERRED EMBODIMENTS

(Embodiment 1)

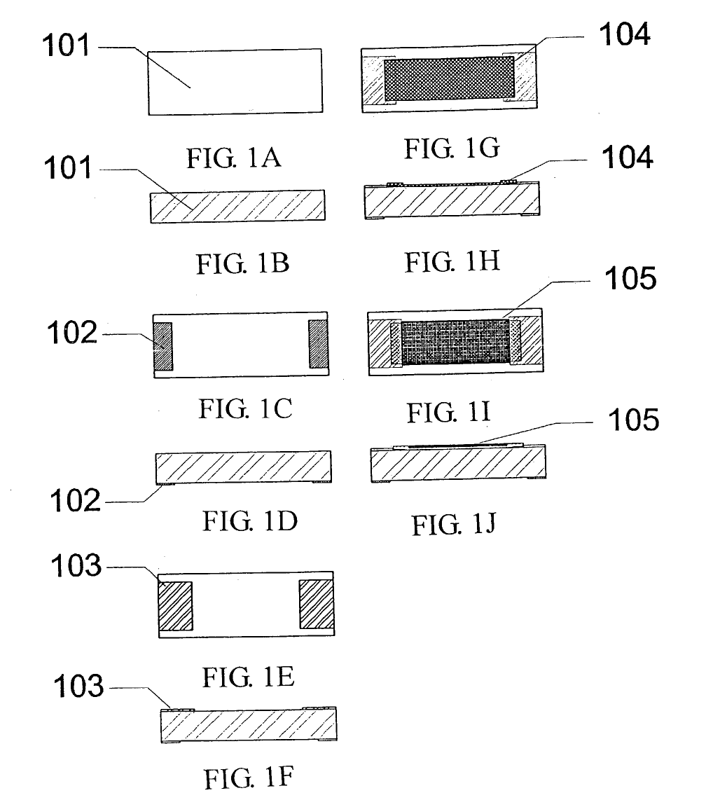

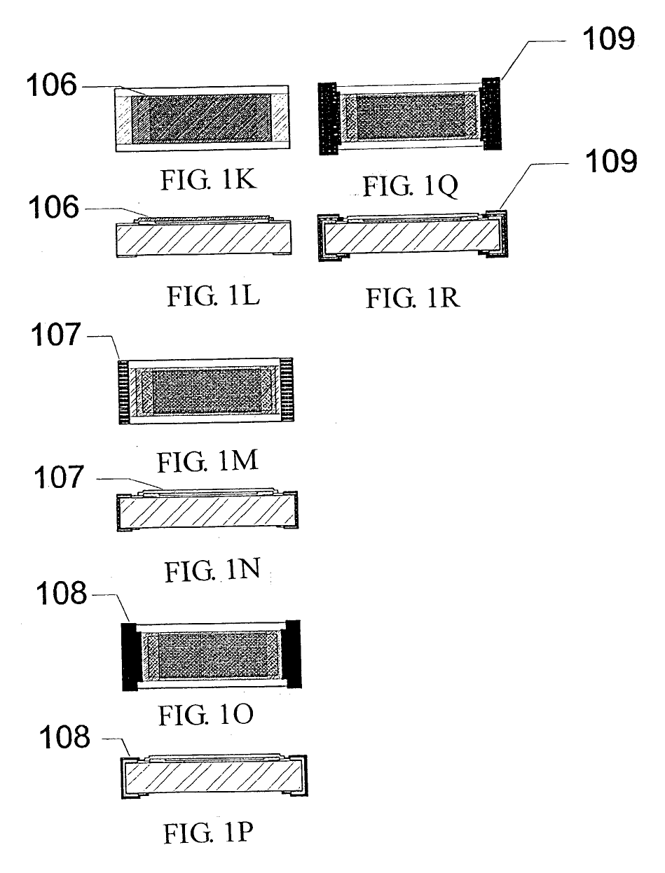

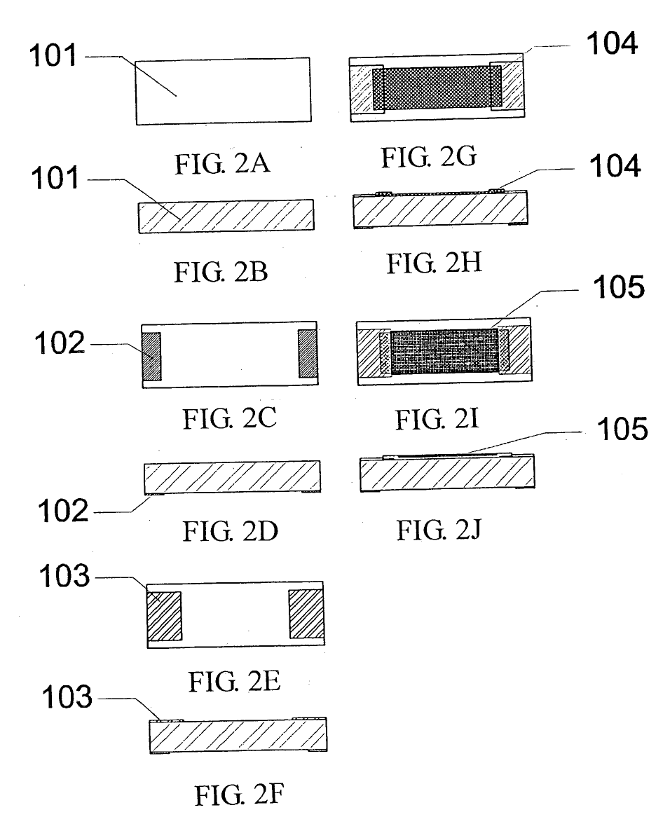

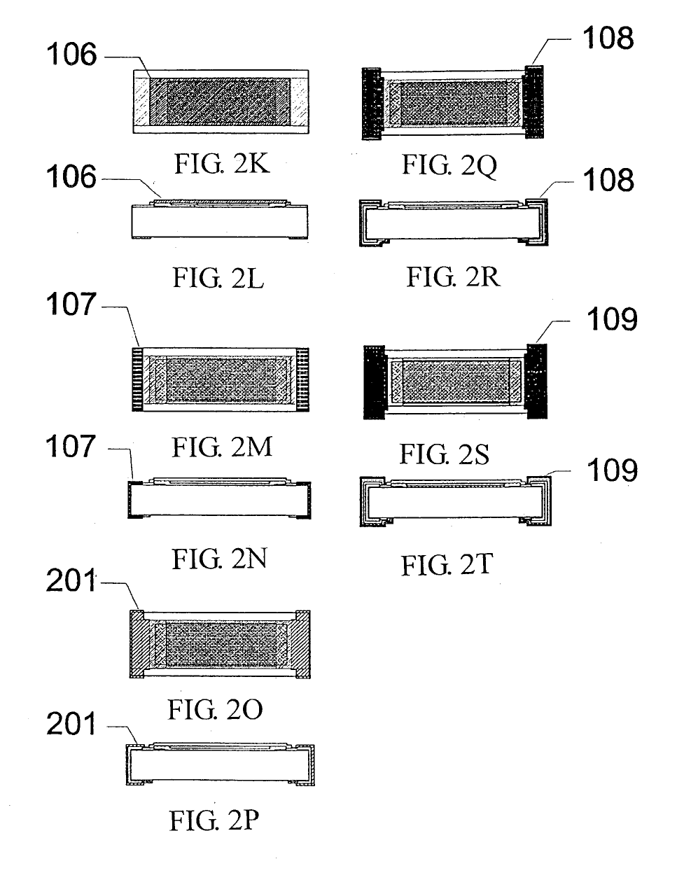

The structure and fabrication process in this embodiment of the present invention is shown in FIGS. 2A to 2N, and FIGS. 2Q to 2T which are similar to the conventional chip type thick film resistance described in FIG. 1. Firstly, a conducting electrode layer 102 (See FIGS. 2C, 2D) is formed by coating on each side of the bottom surface of a ceramic substrate 101 (See FIGS. 2A, 2B); next, another conducting electrode 103 (See FIGS. 2E, 2F) is formed by coating on each side of the top surface thereof, further, a resistance layer 104 is formed by coating on the center portion of the top surface thereof (See FIGS. 2G, 2H); then, an insulation coating layer 105 is overlapped on the resistance layer 104 (See FIGS. 2I, 2J); afterwards, a resistance protecting layer 106 is covered on the insulation coating layer 105 by coating (See FIGS. 2K, 2L); moreover, a conducting electrode connecting layer 107 is coated on the electrode layers 102 and 103 which have been respectively formed on the top and bottom surfaces of the ceramic substrate 101 (See FIGS. 2M, 2N); finally, a first soldering interface layer 108 (See FIGS. 2Q, 2R), and a second soldering interface layer 109 (See FIGS. 2S, 2T) are coated respectively on the top and the bottom surfaces' conducting electrode connecting layers 107 in order.

The kernel of this first embodiment is that an electroplated copper structure 201 (See FIGS. 2O, 2P) is intercalated between the conducting electrode connecting layer 107 (See FIGS. 2M, 2N) and the first soldering interface layer 108 (See FIGS. 2Q, 2R) such that the resistance of this improved structure for the chip type thick film is remarkably reduced and the resistance value of the conducting electrode is evenly distributed thereby the succeeding laser resistance trimming can be precisely performed. Besides, the thermal resistivity of this element can also be greatly reduced.

(Embodiment 2)

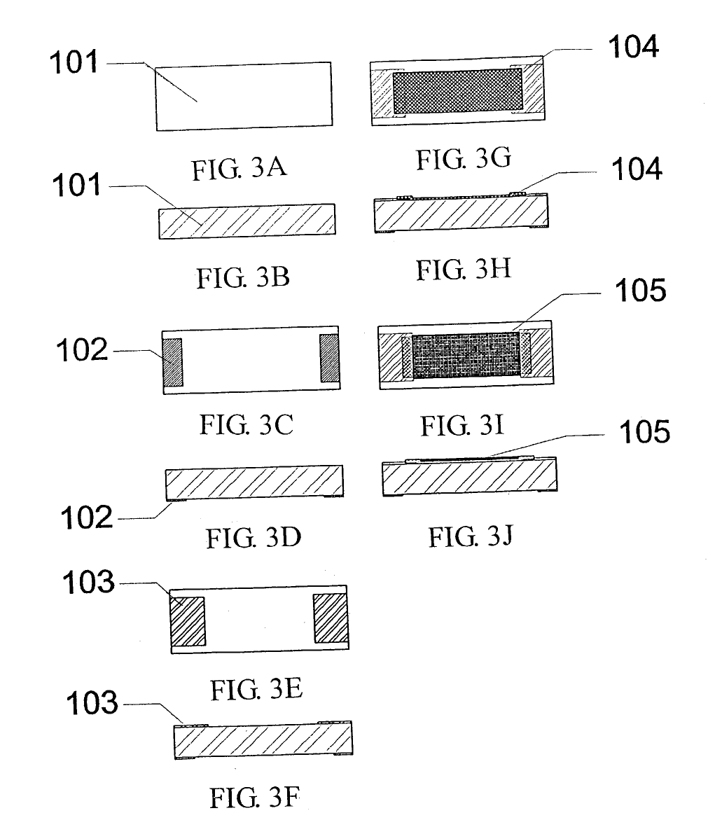

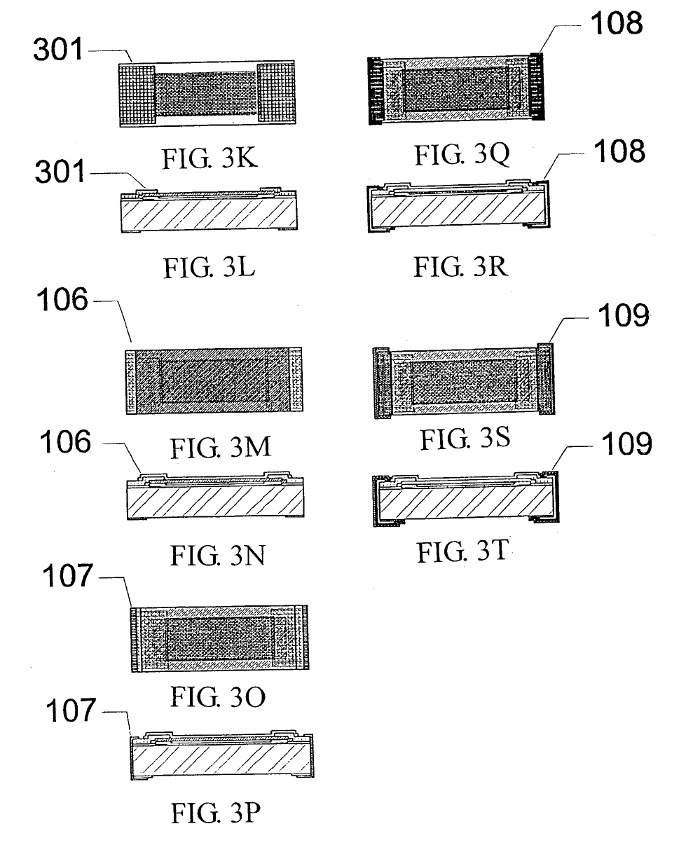

The structure and fabrication process shown in FIGS. 3A to 3J, and FIGS. 3M to 3T are similar to that shown in the first embodiment and the conventional product shown in FIG. 1 as well. Firstly, a conducting electrode layer 102 (See FIGS. 3C, 3D) is formed by coating on each side of a ceramic substrate 101 (See FIGS. 3A, 3B); next, another conducting electrode 103 (See FIGS. 3E, 3F) is formed by coating on each side of the top surface thereof; further a resistance layer 104 is formed by coating on the center portion of the top surface thereof (See FIGS. 3G, 3H); then, an insulation coating layer 105 is overlapping on the resistance layer 104 (See FIGS. 3I, 3J); afterwards, a resistance protecting layer 106 is covered on the insulation coating layer 105 by coating (See FIGS. 3M, 3N); moreover, a conducting electrode connecting layer 107 is coated on the electrode layers 102 and 103 which have been respectively formed on the top and bottom surfaces of the ceramic substrate 101 (See FIGS. 3O, 3P); finally, a first soldering interface 108 (See FIGS. 3Q, 3R), and a second soldering interface layer 109 (See FIGS. 3S, 3T) are coated respectively on the top and the bottom surfaces' conducting electrode connecting layers 107 in order.

Here, the kernel of the second embodiment is that an electroplated copper structure 301 (See FIGS. 3K, 3L) is intercalated between the insulation coating layer 105 (See FIGS. 3I, 3J) and the resistance protecting layer 106 (See FIGS. 3M, 3N) so as to deeply insert this cooper structure 301 having very low resistance beneath the last resistance protecting layer 106 thereby remarkably reducing the resistance of the chip type thick film and facilitating succeeding laser resistance trimming able to be precisely performed with the aid of evenly distributed resistance value of the conducting electrode. Besides, the thermal resistivity of the product can also be greatly reduced.

It is understood from the above description that the structure of the chip type thick film resistance according to the present invention has noteworthy advantages, namely:

1. The resistance of the product is remarkably reduced, and the resistance distribution on the conducting electrode is very uniform that greatly facilitates precise laser resistance trimming for the product.

2. The thermal resistivity of the product can be greatly reduced.

Those who are skilled in the art will readily perceive how to modify the invention. Therefore, the appended claims are to be construed to cover all equivalent structures, which fall within the true scope and spirit of the invention.

What is claimed is:

1. A chip type thick film resistance comprising a copper structure electroplated to the conductor portion on an insulation coating layer.

2. A chip type thick film resistance comprising a copper structure electroplated to the conductor portion beneath a soldering interface layer.

3. A chip type thick film resistance comprising a copper structure electroplated to the conductor portion on an insulation coating layer; and another copper structure electroplated to the conductor portion beneath a soldering interface layer.
